(19) United States
(12) Patent Application Publication
(10) Pub. No.: US 2012/0084148 A1
(43) Pub. Date: Apr. 5, 2012

(54) ADVERTISEMENT INFORMATION PROVIDING SYSTEM THROUGH RECOGNITION OF SOUND AND METHOD THEREOF

(75) Inventor: Man Ho WON, Seongnam-si (KR)

(73) Assignee: NHN CORPORATION, Seongnam-si (KR)

(21) Appl. No.: 13/243,728

(22) Filed: Sep. 23, 2011

(30) Foreign Application Priority Data
Oct. 1, 2010 (KR) 10-2010-0095898

(51) Int. Cl. G06Q 30/00

(52) U.S. Cl. 705/14.49

(57) ABSTRACT

Provided is a method and system for providing advertisement information through recognition of a sound. The advertisement information providing system may include a sound receiving unit to receive, via a mobile terminal, an external sound that is recognized through the mobile terminal, an information retrieving unit to retrieve advertisement information associated with the external sound, an information providing unit to provide the retrieved advertisement information to the mobile terminal, and a charging unit to charge an advertiser corresponding to the provided advertisement information for providing the retrieved advertisement information.

### CROSS-REFERENCE TO RELATED APPLICATION

This application claims priority from and the benefit of Korean Patent Application No. 10-2010-0095898, filed on Oct. 1, 2010, which is hereby incorporated by reference for all purposes as if fully set forth herein.

### BACKGROUND OF THE INVENTION

1. Field of the Invention

Exemplary embodiments of the present invention relate to an advertisement providing method and system that may recognizes a sound from a broadcasting medium, for example, a television (TV), and a radio, and may provide associated advertisement information.

2. Discussion of the Background

Since televisions (TVs) and radios are uni-directional media that provide information in a one-way format, a user may not be able to access advertisements from TVs or radios in an interactive way. The TV advertisements may be utilized as a scheme of displaying a keyword associated with a search advertisement window in a form of a cross media advertisement so as to induce users to search for the keyword using a computing device, for example, a personal computer, a personal digital assistant (PDA), and a wireless terminal. However, this scheme may be difficult for a user to perform searching unless the user is in an environment where the user is able to perform an immediate search for the keyword. The radio advertisements may use a voice scheme of including a comment to be read as “Please refer to a website of an advertiser” in content provided to an audience. However, not many members of the audience can remember the comment and perform searching accordingly.

Due to its mobility, a mobile terminal, however, may be permits a user to search for information while watching TV or listening to the radio regardless of user's location. In spite of the mobility, not many users perform searching due to the mobile terminal's typically small keyboard.

Therefore, there is a need for an approach for providing enhanced advertisement information service.

### SUMMARY OF THE INVENTION

These and other needs are addressed by the present invention, in which exemplary embodiments of the present invention provide a method and system for is providing advertisement information and capable of recognizing a sound of an advertisement broadcasted from a broadcasting medium, for example, TV, and a radio, and providing information matching the corresponding advertisement and thus, a user may readily obtain additional information associated with the advertisement.

Additional features of the invention will be set forth in the description which follows, and in part will be apparent from the description, or may be learned by practice of the invention.

Exemplary embodiments of the present invention disclose an advertisement information providing system. The system includes a sound receiving unit configured to receive, via a mobile terminal, an external sound corresponding to a sound broadcasted from a broadcast medium. The system also includes an information retrieving unit, executed by a processor, configured to retrieve advertisement information associated with the external sound, wherein a non-transitory storage medium is configured to store the advertisement information. The system includes an information providing unit configured to provide the retrieved advertisement information to the mobile terminal. And a charging unit is configured to charge an advertiser for providing the retrieved advertisement information.

Exemplary embodiments of the present invention disclose a method. The method includes receiving, via a mobile terminal, an external sound corresponding to a sound recognized via the mobile terminal. The method also includes retrieving advertisement information associated with the external sound. The method includes providing the retrieved advertisement information to the mobile terminal. The method includes charging an advertiser corresponding to the provided advertisement information.

Exemplary embodiments of the present invention disclose an apparatus. The apparatus includes a processor configured to receive an external sound via a mobile terminal, the external sound being broadcasted from a broadcasting medium and to extract an external audio information corresponding to audio information of the external sound by analyzing an advertisement sound corresponding to audio data of an advertisement to extract an internal audio information corresponding to audio information of the advertisement. The apparatus includes a non-transitory storage medium configured to store advertisement information associated with the internal audio information of the audio data of the advertisement, and wherein advertisement matching to the external sound is retrieved by comparing the external audio information with the internal audio information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a relationship between an advertisement information providing system and a mobile terminal according to exemplary embodiments of the present invention.

FIG. 2 is a block diagram illustrating a diagram of an advertisement information providing system that compiles advertisement information associated with a sound of an advertisement broadcasted from a broadcasting medium according to exemplary embodiments of the present invention.

FIG. 3 is a block diagram illustrating advertisement information providing system capable of recognizing a sound through a mobile terminal, and providing, to the mobile terminal, advertisement information corresponding to the recognized sound according to exemplary embodiments of the present invention.

FIG. 4 is a flowchart of a process for illustrating an advertisement information providing method that is capable of compiling advertisement information associated with a sound from an advertisement broadcasting medium, and providing, to a mobile terminal, with the advertisement information according to exemplary embodiments of the present invention.

FIG. 5 is a flowchart of a process for illustrating an advertisement information providing method that capable of retrieving advertisement information corresponding to a sound recognized through a mobile terminal, providing the corresponding advertisement information to the mobile terminal, and charging for providing the advertisement information according to exemplary embodiments of the present invention.

FIG. 6 is a diagram of hardware that can be used to implement an embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

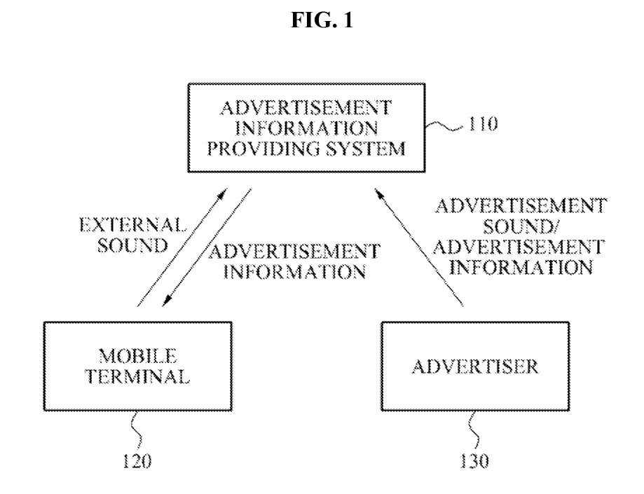

FIG. 1 illustrates a relationship between an advertisement information providing system 110 and a mobile terminal 120 according to exemplary embodiments of the present invention.

Referring to FIG. 1, the advertisement information providing system 110 operates with the mobile terminal 120 and provides an advertisement to the mobile terminal 120.

The advertisement information providing system 110 may receive an advertisement sound corresponding to audio data of an advertisement broadcasted through a broadcasting medium, and may compile, in a database (DB), advertisement information associated with the received advertisement sound to be provided to the mobile terminal 120. In this example, an advertiser 130 may include an advertising agency, and the broadcasting medium may be, for example, a television (TV), and a radio.

The mobile terminal 120 may recognize a sound broadcasted from the broadcasting medium, and may transmit the recognized sound to the advertisement information providing system 110. In this example, the mobile terminal 120 may be various kinds of devices (e.g., a computing device, a personal computer, a personal digital assistant (PDA), and a wireless terminal) that are able to perform network access so as to communicate with the advertisement information providing system 110. The mobile terminal 120 may support various functions including a function of recognizing an external sound, a function of receiving advertisement information provided from the advertisement information providing system 110, for example, a function of displaying received advertisement information, a function of calling a webpage, a video player, a map application, and an address book by clicking on advertisement information, and a function of transmitting an external sound to the advertisement information providing system 110, while the advertisement information providing system 110 searches for advertisement information.

For example, the advertisement information providing system 110 may receive, from the mobile terminal, the sound recognized through the mobile terminal 120. Hereinafter, the recognized sound may be referred to as an external sound. The advertisement information providing system 110 may retrieve advertisement information that matches the external sound by comparing the external sound and advertisement sounds, and may provide corresponding advertisement information to the mobile terminal 120. The advertisement information providing system 110 may support a function of automatically and successively providing advertisement information associated with a subsequent sound transmitted from the mobile terminal 120 until the advertisement information associated with the external sound is checked during a predetermined period of time. A user may readily and quickly obtain additional information associated with the external sound by checking advertisement information provided to the mobile terminal 120.

The advertisement information providing system 110 may charge the advertiser 130 corresponding to advertisement information for providing the advertisement information to the mobile terminal 120.

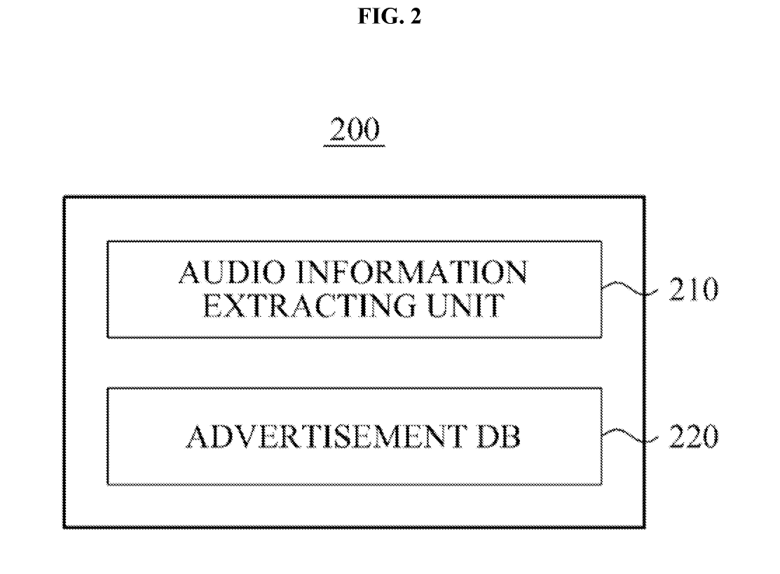

FIG. 2 illustrates configuration diagram of an advertisement information providing system 200 that compiles advertisement information associated with a sound of an advertisement broadcasted from a broadcasting medium, e.g., TV and a radio according to exemplary embodiments of the present invention.

Referring to FIG. 2, the advertisement information providing system 200 may include an audio information extracting unit 210, and an advertisement database (DB) 220.

The DNA extracting unit 210 may extract audio information of an advertisement sound from all sections of the advertisement sound by analyzing the advertisement sound obtained from an advertiser or broadcasting medium. Hereinafter, audio information of an advertisement sound may be referred to as an internal DNA. In this example, audio information of a sound may be denoted as an audio characters obtained based on an audio fingerprint of audio data. The audio information may be classified, for example, based on a key of the audio data and a beat of the audio data. The audio information extracting unit 210 may extract at least one internal audio information from audio data corresponding to the advertisement sound, based on the key and the beat, as an example. For example, the audio information includes at least one of frequency of sound, wavelength of sound, amplitude of sound, sound intensity, sound pressure, speed of sound, sound direction, or any combination thereof.

The audio information extracting unit 210 may extract an internal audio information in the same manner as an audio information extracting system that determines whether a digital sound source is an illegally copied digital sound source. When an advertiser provides internal audio information corresponding to advertisement sound, the advertisement information providing system 200 may not need to include the audio information extracting unit 210.

The advertisement data base 220 may store advertisement information registered by an advertiser, and may maintain and manage advertisement information for each advertiser. In this example, the advertisement information may be denoted as various types or formats of advertisements that are able to be provided to a mobile terminal. The advertisement DB 220 may store advertisement information associated with an advertisement sound to be associated with an internal audio information, and may maintain the stored advertisement information. For example, the advertisement DB 220 may include a field that stores and manages one of an internal audio information, a name or a telephone number of an advertiser, a name or a title type of an advertisement, a character of an advertisement, content of an advertisement, a number of successful matches after recognizing a sound, a number of successful transmissions of advertisement information to a mobile terminal, a number of times that an advertisement is provided for each type of advertisement information, or any combination thereof.

According to the above-described configuration, the advertisement information providing system 200 may maintain, using the advertisement DB 220, advertisement information corresponding to an advertisement sound and thus, may provide, to a mobile terminal, advertisement information that matches a sound recognized through the mobile terminal. When a user desires to obtain information associated with an advertisement broadcasted from a broadcasting medium, a sound obtained through a mobile terminal is transmitted to the advertisement information providing system 200 and the advertisement information providing system 200 may provide additional information associated with the advertisement which matches the sound. To perform the foregoing operation, the mobile terminal having a network communication including wireless network may execute an application for recognizing an external sound and may operate a sound recognizing function included in the application so as to recognize the external sound broadcasted from a broadcasting medium. For example, the mobile terminal may continuously transmit a portion or whole of the external sound to the advertisement information providing system 200 via a network until the advertisement information providing system 200 successfully performs sound matching. In this example, the mobile terminal may automatically store the external sound in the mobile terminal so that the mobile terminal may reuse the stored external sound. The mobile terminal may transmit location information to the advertisement providing system 200. The location information may be denoted as location data of the mobile terminal or location data selected by the user. The advertisement information providing system 200 may receive the location information from the mobile terminal, and may provide, the mobile terminal, advertisement information corresponding to the location information, that is, an advertisement targeting a corresponding location, among advertisement information stored in the advertisement DB 220.

Hereinafter, an advertisement information providing system that provides advertisement information to a mobile terminal will be described in detail.

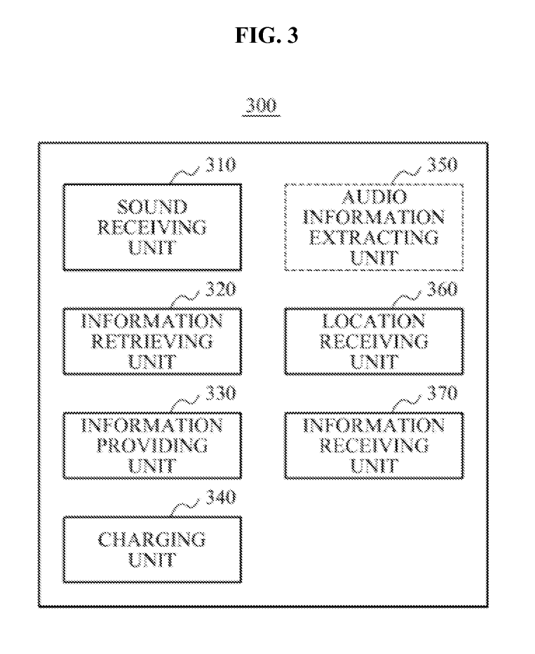

FIG. 3 illustrates a diagram of an advertisement information providing system 300 that recognizes a sound through a mobile terminal, and provides, to the mobile terminal, advertisement information corresponding to the recognized sound according to exemplary embodiments of the present invention.

Referring to FIG. 3, the advertisement information providing system 300 may include, for example, a sound receiving unit 310, an audio information extracting unit 350, an information retrieving unit 320, an information providing unit 330, a charging unit 340, a location receiving unit 360, and an information receiving unit 370.

The sound receiving unit 310 may receive an external sound recognized through the mobile terminal, from the mobile terminal.

The audio information extracting unit 350 may extract an external audio information corresponding to audio information of the external sound by analyzing the external sound. In this example, the external audio information may be denoted as an audio information generated based on an audio fingerprint of audio data corresponding to the external sound. For example, the DNA extracting unit 350 may extract at least one external audio information from audio data corresponding to the external sound, based on, for example, a key, a tempo, a tone, a pitch, and a beat. The audio information extracting unit 350 may extract external audio information in the same manner as an audio information extracting system that determines whether a digital sound source is an illegally copied digital sound source. For example, the audio information extracting unit 350 may be included in the mobile terminal. When the audio information extracting unit 350 is included in the mobile terminal, the mobile terminal may extract an external audio information of the external sound and may transmit the extracted external audio information to the advertisement information providing system 300. In this example, the advertisement information providing system 300 may not need to include the audio information extracting unit 350 and may receive an external audio information of the external sound through the sound receiving unit 310.

The information retrieving unit 320 may retrieve advertisement information associated with the external sound. The information retrieving unit 320 may compare the external audio information extracted from the external sound with all internal audio information stored in the advertisement DB 220 to retrieve an internal audio information matching the external audio information, and may retrieve advertisement information associated with the retrieved internal audio information.

The information providing unit 330 may provide the advertisement information, retrieved by comparing the external audio information and internal audio information, to the mobile terminal that transmits the external sound, by pushing the retrieved advertisement information. For example, advertisement information may include a name or a telephone number of an advertiser, a name or a title of an advertisement, content of an advertisement, reaction information of other users with respect to an advertisement, or any combination thereof. The information providing unit 330 may provide, based on a type of the advertisement information, the advertisement information in at least one form of a search keyword, a uniform resource locator (URL), or the both of the search keyword form and the URL form that links to a corresponding webpage, a URL that is able to execute a moving picture, a URL that links to a location on a map, or a text or a document that is storable. When the internal audio information matching the external audio information is absent from the advertisement DB 220, the information providing unit 230 may transmit a fail signal to the mobile terminal.

The location receiving unit 360 may receive location information of the mobile terminal or location information selected by a user, from the mobile terminal. In this example, the information providing unit 330 may provide, to the mobile terminal, advertisement information corresponding to the location information, that is, an advertisement targeting the corresponding location among advertisements stored in the advertisement DB 220. When an advertisement corresponding to the location information is absent from the advertisement DB 220, the information providing unit 330 may transmit a fail signal to the mobile terminal. When the mobile terminal does not provide location information or does not request an advertisement targeting a location, the advertisement information providing system 300 may not need to include the location receiving unit 360.

As an example, the mobile terminal may receive, from the advertisement information providing system 300, the advertisement information corresponding to the external sound, and may display the advertisement information in a form that the user is able to check. When the mobile terminal completes recognition of the external sound, the mobile terminal may immediately display the advertisement information received from the advertisement information providing system 300. In this example, the received advertisement information may be stored, by default, in the mobile terminal so that the user may use the advertisement information again. For example, when a name or a telephone number of an advertiser, a name or a tile of an advertisement, content of an advertisement, and reaction information of other users with respect to an advertisement, is displayed in a text, a document, an image, or any combination format, the user may immediately use the advertisement information.

When the advertisement information is provided in a form of an URL or a search keyword, the user may click on the URL or the keyword so as to access a corresponding website or a search result page, and may obtain information. For example, when a search keyword or a text to be used for searching is provided, a search result page may be provided by clicking on or inputting the search keyword. When a URL that links to a corresponding webpage is provided, the webpage that provides advertisement information may be provided by clicking on the URL. When a URL that is able to execute a moving picture is provided, the moving picture that provides advertisement information may be played back by clicking on the URL. When a URL that links to a corresponding webpage is provided, a map application that provides a map associated with advertisement information may be provided by clicking on the URL. When the advertisement information is provided in a form of a text, a document, an image, or any combination format, the advertisement information may be stored in a storage box included in the mobile terminal, such as an address book, and a memo box.

When the advertisement information is converted by the user, the mobile terminal may transmit the converted information to the advertisement information providing system 300. In this example, the conversion corresponds to a behavior of the user that is connected to a substantial advertising effect, for example, viewing of a page view, clicking, executing, accessing, and storing, and the converted information may be denoted as a number of displays of page view, a number of clicks, a number of executions, a number of accesses, and a number of times of saving. The mobile terminal may transmit, to the advertisement providing system 300, information associated with which advertisement information is clicked by the user and information associated with a number of times that the corresponding advertisement is clicked to perform a behavior among moving, executing, and storing.

The information receiving unit 370 may receive the converted information including a number of displays of an advertisement as a page view, a number of clicks, a number of executions, a number of accesses, and a number of times of saving. The information receiving unit 370 may collect the converted information associated with the advertisement information through various routes, such as a scheme of directly receiving converted information from the mobile terminal and a scheme of being informed of converted information computed by an advertiser.

The charging unit 340 may charge an advertiser corresponding to the advertisement information for providing the advertisement information. For example, the charging unit 340 may statistically compute one advertisement provision count indicating a number of times that advertisement information is provided, a display count indicating a number of displays of advertisement information, a retrieve count indicating a number of executions of retrieving using a search keyword, a click count indicating a number of clicks on a result retrieved using a search keyword, an execution count indicating a number of executions of a webpage corresponding to a URL by clicking on the URL, a playback count indicating a number of playbacks of a moving picture or a map image by clicking on a URL, a call count indicating a number of call connections using a telephone number, or any combination thereof. The charging unit 340 may charge the advertiser differently based on each item of the statistically computed advertisement provision count. For example, a cost per mille (CPM) scheme may be applied to the display count, a cost per action (CPA) scheme may be applied to the retrieve count, the click count, the execution count, the playback count, and a click to call (CTC) scheme may be applied to the call count.

The advertisement information providing system 300 may recognize an external sound through the mobile terminal, and may provide advertisement information matching the external sound to the mobile terminal.

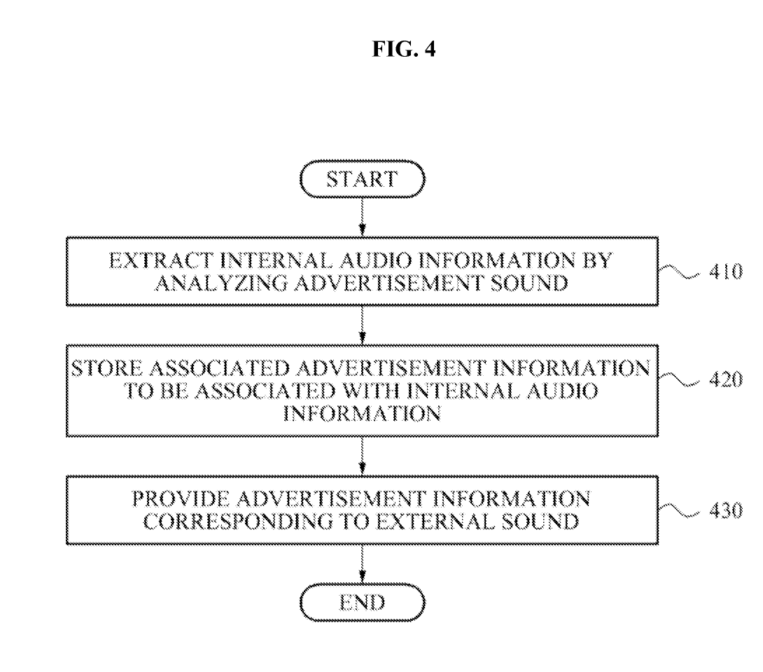

FIG. 4 illustrates an advertisement information providing method that compiles advertisement information associated with a sound from an advertisement broadcasted from a broadcasting medium, for example, TV, and a radio, and provides, to a mobile terminal, the advertisement information according to exemplary embodiments of the present invention. The advertisement information providing method may be performed by the advertisement information providing system 200 of FIG. 2.

In operation 410, the advertisement information providing system 200 may extract internal audio information of an advertisement sound from all sections of the advertisement sound by analyzing the advertisement sound obtained from an advertiser or a broadcasting medium. When the advertiser directly provides the internal audio information corresponding to the advertisement sound, the advertisement information providing system 200 may omit operation 410.

In operation 420, the advertisement information providing system 200 may store advertisement information associated with the advertisement sound to be associated with the internal audio information, and may maintain the advertisement information. In this example, the advertisement information may include one of a name or a telephone number of an advertiser, a name of a title of an advertisement, a type of an advertisement, content of an advertisement, a number of successful matches after recognizing a sound, a number of successful transmissions to a mobile terminal, a number of times that an advertisement is provided for each type of advertisement information, or any combination thereof.

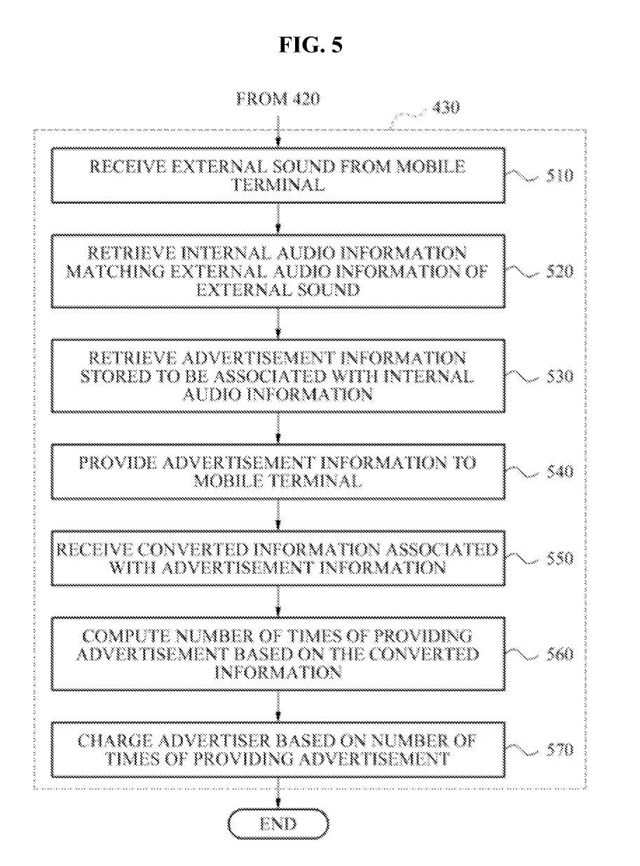

In operation 430, the advertisement information providing system 200 may provide, to the mobile terminal, advertisement information corresponding to an external sound recognized through the mobile terminal. Here, operation 430 will be described in detail with reference to FIG. 5.

FIG. 5 illustrates advertisement information providing method that capable of retrieving advertisement information corresponding to a sound recognized through a mobile terminal, providing the corresponding advertisement information to the mobile terminal, and charging for providing the advertisement information according to exemplary embodiments of the present invention. The advertisement information providing method may be performed by the advertisement information providing system 300 of FIG. 3.

When a user desires information associated with an advertisement broadcasted from a broadcasting medium, a mobile terminal may obtain, using a sound recognizing function, an external sound corresponding to a sound of the corresponding advertisement, and may transmit the external sound to the advertisement information providing system 300.

In operation 510, the advertisement information providing system 300 may receive the external sound from the mobile terminal. The advertisement information providing system 300 may extract external audio information corresponding to audio information of the external sound by analyzing the external sound. When the mobile terminal directly extracts the external audio information of the external sound and provides the extracted external audio information to the advertisement information providing system 300, the advertisement information providing system 300 may omit an operation of extracting the external audio information.

In operation 520 and operation 530, the advertisement information providing system 300 may retrieve internal audio information matching the external audio information by comparing the external audio information extracted in operation 510 and internal audio information, and may retrieve advertisement information stored to be associated with the retrieved internal audio information.

In operation 540, the advertisement information providing system 300 may provide the advertisement information retrieved by comparing the external audio information and the internal audio information, to the mobile terminal that transmits the external sound. The advertisement information provided by the advertisement information providing system 300 may include one of a name or a telephone number of an advertiser, a name or a title of the advertisement, content of the advertisement, reaction information of other users with respect to the advertisement, or any combination thereof. The advertisement information providing system 300 may provide, based on a type of the advertisement information, the advertisement information in various forms including at least one of a search keyword or text, a URL that links to a webpage, a URL that is able to execute a moving picture, a URL that links to a location on a map, a text, document, or an image that is storable.

In operation 550, the advertisement information providing system 300 may receive converted information corresponding to the advertisement information converted by the mobile terminal. In this example, the conversion corresponds to a behavior of the user that is connected to a substantial advertising effect, for example viewing of a page view, clicking, executing, accessing, and storing, and the converted information may be denoted as a number of displays of page view, a number of clicks, a number of executions, a number of accesses, and a number of times of saving. The advertisement information providing system 300 may collect converted information associated with the advertisement information through various routes, such as a scheme of directly receiving the converted information from the mobile terminal and a scheme of being informed of the converted information computed by the advertiser.

In operation 560, the advertisement information providing system 300 may statistically compute, based on the converted information associated with the advertisement information, one of advertisement provision count indicating a number of times that the advertisement is provided, a display count indicating a number of displays of the advertisement information, a retrieve count indicating a number of executions of retrieving using a search keyword, a click count indicating a number of clicks on a result retrieved using a search keyword, an execution count indicating a number of executions of a webpage corresponding to a URL by clicking on the URL, a playback count indicating a number of playbacks of a moving picture or a map image by clicking on a URL, a call count indicating a number of call connections using the telephone number of the advertiser, or any combination thereof.

In operation 570, the advertisement information providing system 300 may charge the advertiser differently based on each item of the statistically computed advertisement provision count. The advertisement information providing system 300 may charge the advertiser for providing the advertisement information, for example, based on a CPM scheme, a CPA scheme, and a CTC scheme.

According to exemplary embodiments, the advertisement information providing system 300 may recognize, through a mobile terminal, a sound of an advertisement broadcasted from a broadcasting medium, and may provide information associated with the corresponding advertisement and thus, the user may readily and quickly obtain additional information associated with the advertisement and active reaction of the user with respect to the advertisement is induced. Accordingly, an advertising effect may be improved.

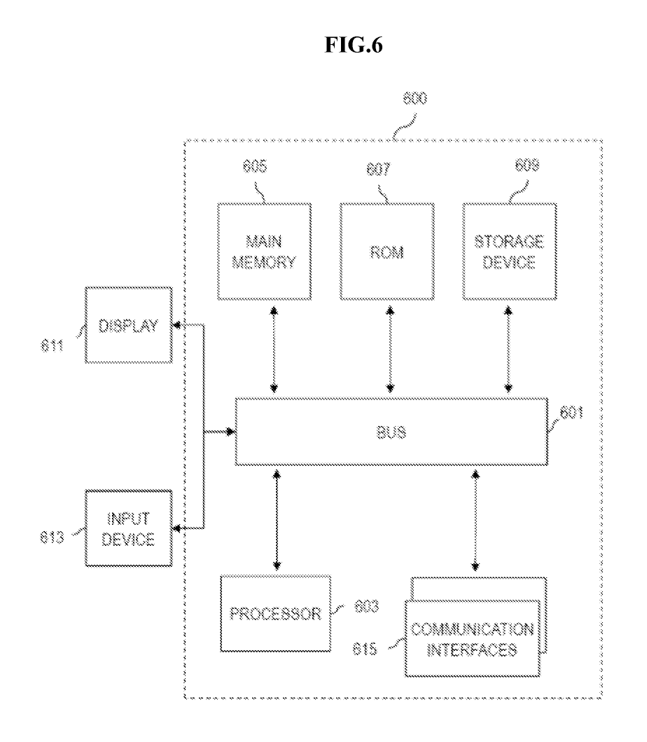

One of ordinary skill in the art would recognize that providing advertising information may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 6.

FIG. 6 illustrates exemplary hardware upon which various embodiments of the invention can be implemented. A computing system 600 includes a bus 601 or other communication mechanism for communicating information and a processor 603 coupled to the bus 601 for processing information. The computing system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computing system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computing system 600 may be coupled via the bus 601 to a display 611, such as a liquid crystal display, or active matrix display, for displaying information to a user. An input device 613, such as a keyboard including alphanumeric and other keys, may be coupled to the bus 601 for communicating information and command selections to the processor 603. The input device 613 can include a cursor control, such as a mouse, a trackball, or cursor direction keys, for communicating direction information and command selections to the processor 603 and for controlling cursor movement on the display 611.

According to various embodiments of the invention, the processes described herein can be provided by the computing system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 600 also includes at least one communication interface 615 coupled to bus 601. The communication interface 615 provides a two-way data communication coupling to a network link (not shown). The communication interface 615 sends and receives electrical, electromagnetic, or optical signals that carry digital data streams representing various types of information. Further, the communication interface 615 can include peripheral interface devices, such as a Universal Serial Bus (USB) interface, a PCMCIA (Personal Computer Memory Card International Association) interface, etc.

The processor 603 may execute the transmitted code while being received and/or store the code in the storage device 609, or other non-volatile storage for later execution. In this manner, the computing system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

According to exemplary embodiments of the present invention, the advertisement information providing system may recognize, through a mobile terminal, a sound of an advertisement broadcasted from a broadcasting medium, and may provide information associated with the corresponding advertisement and thus, the user may readily and quickly obtain additional information associated with the advertisement and active reaction of the user with respect to the advertisement may be induced. Accordingly, an advertising effect may be improved.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An advertisement information providing system, the system comprising:
a sound receiving unit configured to receive, via a mobile terminal, an external sound corresponding to a sound broadcasted from a broadcasting medium;
an information retrieving unit, executed by a processor, configured to retrieve advertisement information associated with the external sound, wherein a non-transitory storage medium is configured to store the advertisement information;
an information providing unit configured to provide the retrieved advertisement information to the mobile terminal; and
a charging unit configured to charge an advertiser for providing the retrieved advertisement information.

2. The system of claim 1, further comprising:
a location receiving unit to receive location information of the mobile terminal from the mobile terminal,
wherein the information retrieving unit is configured to retrieve advertisement information associated with the location information.

3. The system of claim 1, wherein
the mobile terminal comprises an audio information extracting unit and is configured to analyze the external sound to extract an external audio information corresponding to audio information of the external sound; and
the advertisement information providing system is configured to receive the external audio information from the mobile terminal and is configured to provide advertisement information corresponding to the external audio information.

4. The system of claim 1, further comprising:
an audio information extracting unit configured to analyze the external sound to extract an external audio information corresponding to audio information of the external sound,
wherein the information retrieving unit is configured to retrieve the advertisement information corresponding to the external audio information.

5. The system of claim 1, further comprising:
an audio information extracting unit configured to analyze an advertisement sound corresponding to audio data of an advertisement to extract an internal audio information corresponding to audio information of the advertisement sound; and
an advertisement database (DB) configured to store advertisement information associated with the advertisement sound associated with the internal audio information.

6. The system of claim 5, wherein the information retrieving unit is configured to retrieve advertisement information associated with the internal audio information that matches the external audio information by comparing the extracted internal audio information with the external audio information.

7. The system of claim 6, wherein the mobile terminal is configured to transmit a portion or whole of the external sound to the advertisement information providing system, and the transmission is continuously performed until the information retrieving unit retrieves the internal audio information matching the external audio information.

8. The system of claim 5, wherein
the advertisement DB comprises a field configured to store one of an internal audio information, a name or a telephone number of an advertiser, a name of an advertisement, a type of an advertisement, content of an advertisement, a number of successful matches after recognizing a sound, a number of successful transmissions of advertisement information to the mobile terminal, a number of times that an advertisement is provided for each type of advertisement information, or any combination thereof; and
the information providing unit is configured to provide the retrieved advertisement information based on a search keyword, a form of a uniform resource locator (URL), or the both of the search keyword and the form of URL comprising one of a name or a telephone number of an advertiser, a name of an advertisement, and content of an advertisement, a URL that links to a corresponding webpage, a URL capable of executing a moving picture, and a URL capable of linking to a location on a map, a text or a document that is storable, or any combinations thereof.

9. The system of claim 8, wherein the charging unit is configured to charge by computing one of a display count indicating a number of displays of the provided advertisement information, a retrieve count indicating a number of executions of retrieving using the search keyword, a click count indicating a number of clicks on a result retrieved using the search keyword, an execution count indicating a number of executions of a webpage corresponding to the URL by clicking on the URL, an playback count indicating a number of playbacks of the moving picture or a map image by clicking on the URL, a call count indicating a number of call connections using the telephone number, or any combination thereof.

10. The system of claim 1, further comprising:
an information receiving unit configured to receive converted information corresponding to the advertisement information converted through the mobile terminal,
wherein the converted information corresponds to a user behavior comprising one of accessing, executing, storing, viewing of a page view, clicking associated with the advertisement information, or any combination thereof; and
the charging unit is configured to compute an advertisement provision count indicating a number of times that the advertisement information is provided based on the converted information, and to charge based on the advertisement provision count.

11. A method using a processor for providing advertisement information, the method comprising:
receiving, via a mobile terminal, an external sound corresponding to a sound recognized via the mobile terminal;
retrieving advertisement information associated with the external sound;
providing the retrieved advertisement information to the mobile terminal; and
charging an advertiser corresponding to the provided advertisement information.

12. The method of claim 11, further comprising:
receiving location information of the mobile terminal,
wherein the retrieving comprises retrieving advertisement information associated with the location information.

13. The method of claim 11, further comprising:
receiving, from the mobile terminal, an external audio information corresponding to audio information of the external sound, the external audio information being extracted by analyzing the external sound; and
retrieving the advertisement corresponding to the external audio information.

14. The method of claim 11, further comprising:
extracting an external audio information corresponding to audio information of the external sound by analyzing the external sound,
wherein the retrieving comprises retrieving the advertisement information corresponding to the external audio information.

15. The method of claim 11, further comprising:
extracting an internal audio information corresponding to audio information of an advertisement sound by analyzing the advertisement sound that corresponds to audio data of an advertisement; and
storing advertisement information associated with the advertisement sound being associated with the extracted internal audio information.

16. The method of claim 15, wherein the retrieving comprises:
retrieving advertisement information associated with an internal audio information that matches an external audio information corresponding to audio information of the external sound by comparing the extracted internal audio information and the external audio information.

17. The method of claim 15, wherein the storing comprises:
storing one of the extracted internal audio information, a name or a telephone number of an advertiser, a name of the advertisement, a type of the advertisement, content of the advertisement, a number of successful matches associated with recognizing the sound, a number of successful transmissions of the advertisement information to the mobile terminal, and a number of time that the advertisement is provided for each type of advertisement information; and
providing the retrieved advertisement information associated with a search keyword, a form of a uniform resource locator (URL), or the both of the search keyword and the form of URL comprising one of a name or a telephone number of an advertiser, a name of an advertisement, and content of an advertisement, a URL that links to a corresponding webpage, a URL capable of executing a moving picture, and a URL capable of linking to a location on a map, a text or a document that is storable, or any combination thereof.

18. The method of claim 17, further comprising:
charging by computing one of a display count indicating a number of displays of the provided advertisement information, a retrieve count indicating a number of executions of retrieving using the search keyword, a click count indicating a number of clicks on a result retrieved using the search keyword, an execution count indicating a number of executions of a webpage corresponding to the URL by clicking on the URL, an playback count indicating a number of playbacks of the moving picture or a map image by clicking on the URL, a call count indicating a number of call connections using the telephone number, or any combination thereof.

19. The method of claim 11, further comprising:
receiving converted information corresponding to the advertisement information converted via the mobile terminal,
wherein
the converted information corresponds to a user behavior comprising one of accessing, executing, storing, viewing of a page view, clicking associated with the advertisement information, or any combination thereof; and
the charging unit is configured to compute an advertisement provision count indicating a number of times that the advertisement information is provided based on the converted information, and to charge based on the advertisement provision count.

20. An apparatus comprising:
a processor configured to receive an external sound via a mobile terminal, the external sound being broadcasted from a broadcasting medium and to extract an external audio information corresponding to audio information of the external sound by analyzing an advertisement sound corresponding to audio data of an advertisement to extract an internal audio information corresponding to audio information of the advertisement, wherein a non-transitory storage medium is configured to store advertisement information associated with the internal audio information of the audio data of the advertisement, and wherein advertisement matching to the external sound is retrieved by comparing the external audio information with the internal audio information.

21. The apparatus of claim 20, wherein the audio information comprises a frequency of sound, a wavelength of sound, an amplitude of sound, sound intensity, sound pressure, speed of sound and sound direction.
